(19) United States
(12) Patent Application Publication
(10) Pub. No.: US 2002/0109645 A1
(43) Pub. Date: Aug. 15, 2002

(54) Interactive display extension device

(75) Inventor: Colin Hendrick, Brooklyn, NY (US)

Correspondence Address: Norman H. Zivin, Cooper & Dunham LLP, 1185 Avenue of the Americas, New York, NY, 10036, US

(73) Assignee: Applied Computing Science Inc.

(21) Appl. No.: 09/781,370

(22) Filed: Feb. 12, 2001

(51) Int. Cl. G09G 5/00

(52) U.S. Cl. 345/1.1

(57) ABSTRACT

An interactive display extension device for use with a computer system, for displaying certain information to a user without taking up space on the existing computer screen. A memory stores information from the computer system. A processor processes the information stored in the memory. A display, separate from a display of the computer system, displays the information processed by the processor. A user is allowed to interact with the interactive display extension device to request additional information to be displayed.

### FIELD OF THE INVENTION

The present invention relates to the field of display extension devices for use with existing computer screens and monitors. More particularly, the present invention relates to an interactive display extension device separate from the user's existing computer screen for displaying information with which the user can interact for various purposes.

### BACKGROUND OF THE INVENTION

It has been found beneficial to allow computer users to view certain displayed information (e.g., advertising information) which may not be related to the task on which they are working. Typically, the information is displayed to the user on the computer screen in an area located towards the perimeter or edges of the screen. In this manner, the user is able to work at the computer task and view the information at the same time.

When the information is displayed on the same screen on which the user is working, the user is inconvenienced because the displayed information takes up some of the screen space. Therefore, the user, in effect, suffers a loss of screen space.

Further, the information provider (e.g., an advertiser) has only a relatively small amount of space on the computer screen to display the information which is requested by the user.

### SUMMARY OF THE INVENTION

The present invention is designed to solve the above problems. The present invention relates to an interactive display extension (IDE) device for use with existing computer systems (personal computers, etc.).

It is an object of the present invention to provide an extension of screen display space for displaying certain information to a user without taking up space on the existing computer screen or monitor. Information that can be provided includes advertisements, news, stocks, sports, weather, traffic, and emergency information.

It is also an object of the present invention to allow the information provider to have a large amount of space to display the information.

It is also an object of the present invention to provide a display extension device which is interactive so that the user can request that the information displayed on the display extension device be provided in more detail, or the user can specifically request that additional information be provided.

It is also an object of the present invention to provide an interactive display extension device with smart card functionality incorporated therein so that a user may immediately complete a transaction to purchase an item advertised on the interactive display extension device while connected to the internet.

The present invention in one embodiment is an interactive display extension device for use with a computer system, comprising: memory means for storing information from the computer system; processing means for processing the information stored in the memory means; and display means, separate from a display means of the computer system, for displaying the information processed by the processing means. A user is allowed to interact with the interactive display extension device to request additional information to be displayed.

The information may be displayed on the display means of the interactive display extension device in static and/or moving images. The information may be displayed in text and/or graphic form.

The interactive display extension device may further comprise audio output means for outputting the information in audio form. A data display bar may be displayed on the display means of the computer system to facilitate user interaction with the information displayed on the display means of the interactive display extension device. The additional information may be displayed on either display means.

The interactive display extension device may further comprise attachment means for mechanically attaching the interactive display extension device to the display means of the computer system. The attachment means in one embodiment wraps around the display means of the computer system and clasps onto an edge of the display means of the computer system. The attachment means may comprise a plurality of L-shaped arms, which are movable to adjust a position of the interactive display extension device in relation to the display means of the computer system.

The present invention in another embodiment provides a method for displaying information on a separate display from a display of a computer system, comprising the steps of:

storing information from the computer system; processing the stored information; displaying, on a separate display from the display of the computer system, the processed information; and

allowing user interaction so that a user may request additional information to be displayed.

The present invention in another embodiment provides an interactive display extension system for use with a computer system, comprising: a memory for storing information from the computer system; a processor for processing the information stored in the memory; and a display, separate from a display of the computer system, for displaying the information processed by the processor, wherein a user is allowed to interact with the information displayed on the display of the interactive display extension system to request additional information to be displayed. The system further comprises a data card which contains user information; a data card reader adapted to access the user information contained on the data card when the data card is in communication therewith; and an application program configured to allow the user to complete a transaction over a network, based on the information or additional information displayed on the display, using the user information when the data card is in communication with the data card reader.

### BRIEF DESCRIPTION OF THE FIGURES

FIG. 1 illustrates the interactive display extension device according to one embodiment;

FIG. 2 is a block diagram illustrating the components of the interactive display extension device according to one embodiment;

FIG. 3 illustrates a smart card; and

FIG. 4 illustrates a smart card reader.

### DETAILED DESCRIPTION OF THE INVENTION

The interactive display extension device of the present invention is designed to be used in conjunction with existing computer systems. The invention provides an extension of screen display space for providing information to a user without taking up space on the existing computer screen or monitor. Information that can be provided includes, but is not limited to, advertisements, news, stocks, sports, weather, traffic, and emergency information. In short, all forms of data services may be provided. This information may be retrieved from the internet while the user is online.

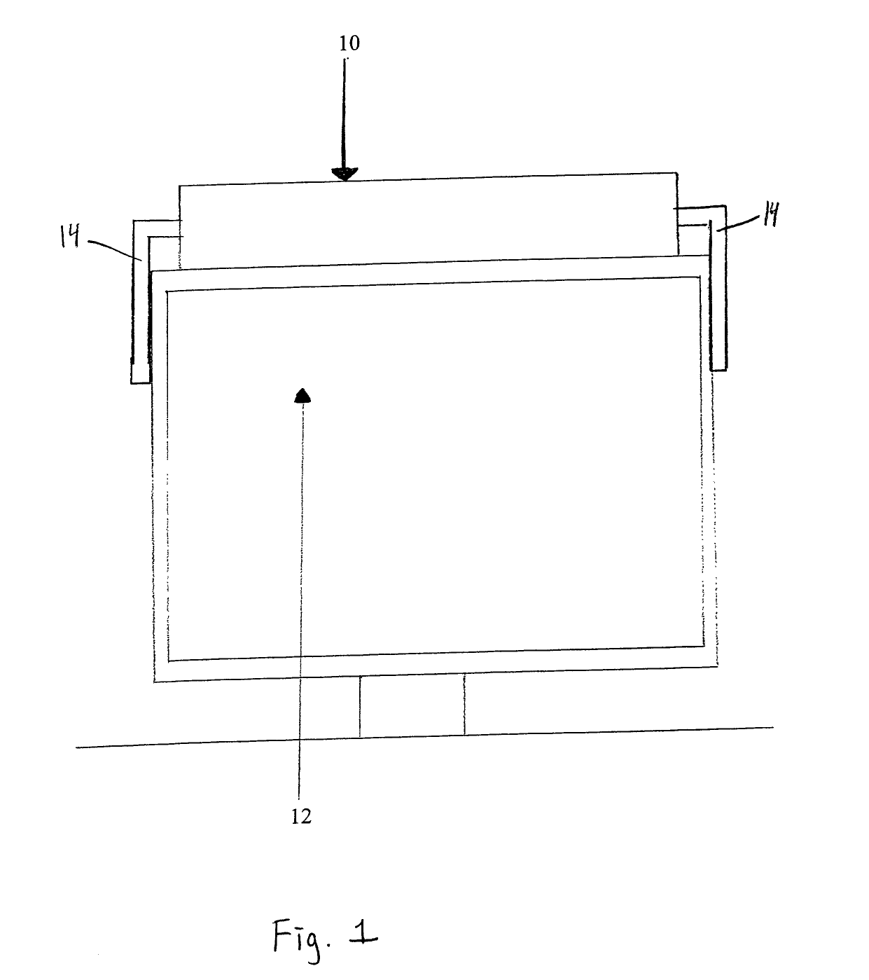

The interactive display extension device is designed to be placed on top of or next to the user's existing computer monitor. It may be physically attached to the computer monitor, or may be in a detached state. FIG. 1 illustrates an interactive display extension device 10 according to one embodiment. In FIG. 1, the interactive display extension device 10 is positioned on top of the user's existing computer monitor 12 in an attached state. In this way, the user can easily see both the information displayed on the monitor 12 and the information displayed on the interactive display extension device 10. Because the computer monitor 12 is separate from the interactive display extension device 10, the computer monitor 12 is not cluttered up with information not related to what the user is working on; therefore, screen space on the user's existing computer monitor 12 is saved. At the same time, the user can still view the advertisement information or the like by looking at the interactive display extension device 10.

Various attachment and connection methods may be employed. For example, in the embodiment shown in FIG. 1, the interactive display extension device 10 is attached to the monitor by way of L-shaped arms 14 which wrap around the monitor 12. The arms 14 clasp onto an edge of the monitor and are movable to adjust and position the interactive display extension device 10 in relation to the monitor 12. The arms 14 may be made, for example, of plastic.

Many different types of information may be provided to the user via the interactive display extension device 10. For example, advertising information may be displayed in the form of banner ads. Furthermore, static and/or moving images may be displayed, as well as text and graphics data. The images are preferably displayed in color, but black and white images can be displayed as well. Various types of screen technologies may be used for the interactive display extension device 10, including but not limited to liquid crystal display (LCD) technology and other thin screen technologies. In addition, speakers may be employed to output audio information to the user.

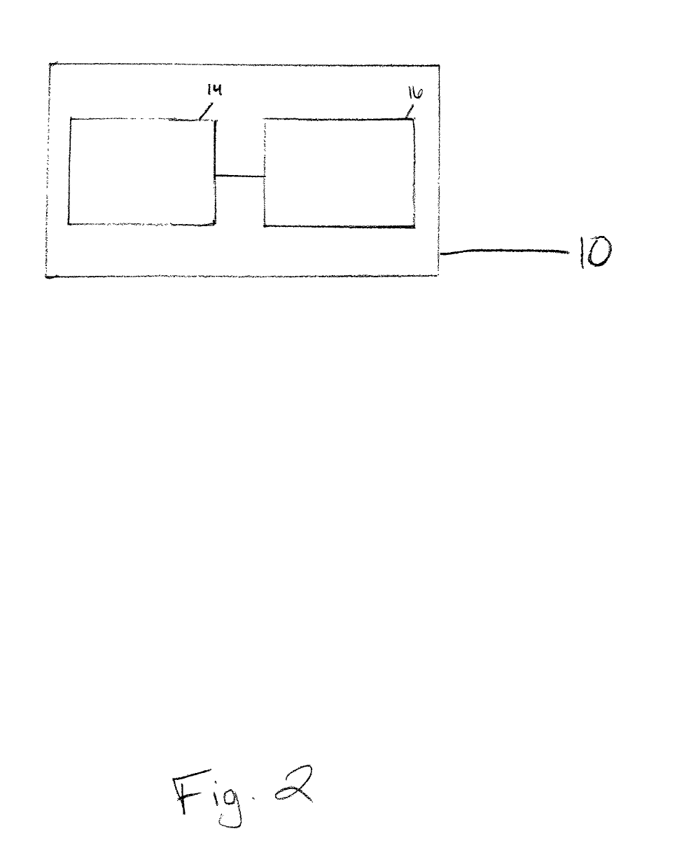

FIG. 2 is a block diagram illustrating the components of the interactive display extension device 10 according to one embodiment. The interactive display extension device 10 of this embodiment is powered by the USB port of the user's computer system, and is connected to the computer system through the USB port (alternatively, a piggyback cable onto the monitor cable could be used, or the serial port could be used). A display processor 14 is used to retrieve the data stream containing the information from the USB port and store it in a memory 16. The processor processes the information stored in the memory, and outputs the information through a buffer to a display. The user's computer system has standard components of a memory, CPU, hard drive, keyboard, monitor, etc.

Advertisement information coming to the interactive display extension device 10 may have a software code attached thereto to be read by the interactive display extension device 10. In this way, advertisement information coming from the internet may be separated from other information coming from the internet.

User interaction with the information display extension device 10 is also provided. In one embodiment, the interactive display extension device 10 is synchronized with the user's existing computer screen or monitor, and there is a mini data display bar (or icon) on the user's existing computer screen. The mini data display bar allows the user to interact with the information being displayed on the interactive display extension device 10. For example, if an advertisement is being displayed on the interactive extension display device 10 and the user is interested in learning more about the advertisement, the user may request additional information about the advertisement simply by moving the cursor using a mouse to the mini data display bar on the existing screen 12. Then, clicking a mouse button would allow the user to interact with the displayed advertisement on the interactive display extension device 10, thereby sending to the existing computer screen 12 additional information about the advertisement for full screen display.

Alternatively, instead of having the existing screen 12 display the additional information requested by the user, the information could be displayed on the interactive display extension device 10. Furthermore, rather than interacting with the display extension device 10 using a mouse, the keyboard of the computer system could be used for the interaction. In this case, the user could press the “Alt” key, or a key sequence which uses the “Alt” key, in order to interact with the display extension device 10.

The present invention provides a number of advantages to the both the user and the information provider. With the information being displayed on the interactive display extension device 10 rather than on the existing computer screen 12, the limited space on the user's existing computer screen 12 is not reduced by the space needed to display the information. Therefore, not only is the user able to more effectively utilize the space of the entire existing computer screen 12, but the information provider (for example, an advertiser) has the ability to display the information to the user on a much larger display area (i.e., on the entire interactive display extension device 10) than that allotted on the existing monitor. Furthermore, as the display extension device 10 is interactive, the user can request that additional or related information be provided.

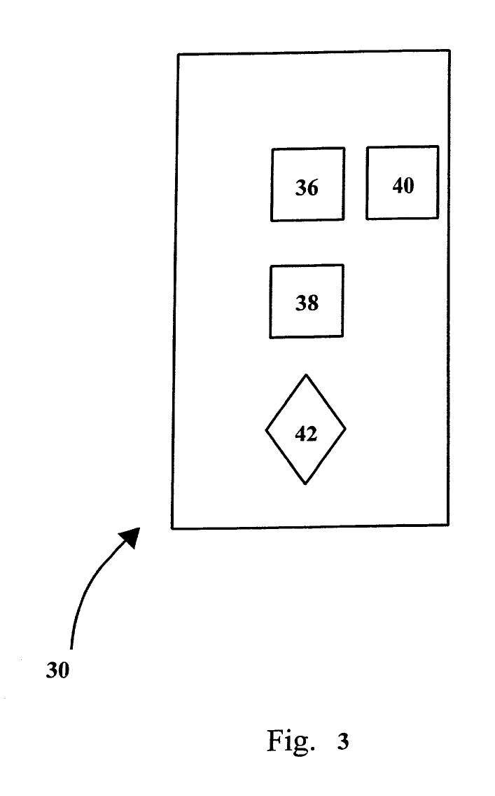

In still another embodiment, a smart card reader is built into the interactive display extension device 10 and smart card functionality is incorporated into the device 10. FIG. 3 shows a smart card or data card 30. The smart card 30 comprises a microprocessor 36 which can process information contained on the smart card 30, a memory component in the form of memory chip 38 which stores the information (e.g., user information) within the data card, a power source in the form of battery 40 which provides power to the microchip so that it can process information, and a communications interface in the form of contact connector 42. The contact connector 42 is exposed to the surface of one side of the smart card 30.

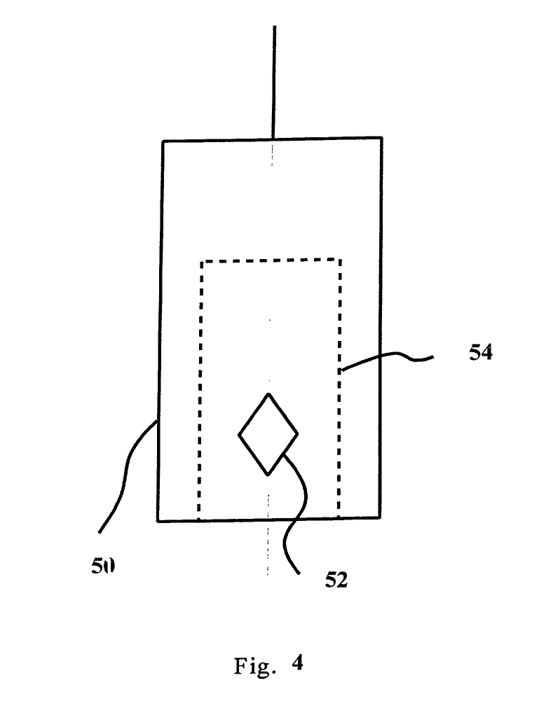

FIG. 4 shows a smart card reader 50 for reading the information contained in the smart card microchip. The smart card reader 50 is typically connected to a data processor in the form of a central processing unit (CPU) located within a computer so that information in the smart card chip 30 can be relayed to the computer. The smart card reader 50 shown in FIG. 4 has an electrical connector 52 which is adapted to make contact with the contact connector 42 whenever the smart card 30 is inserted into recess 54. An application program resident in memory contains code that allows the information contained on the smart card to be processed.

By incorporating this smart card functionality into the interactive display extension device 10 as taught by the present invention, further options and features may be provided to the user. If the user sees an advertisement for a certain product being displayed on the interactive display extension device 10 while connected to the internet, the user may insert his or her smart card 30 (containing the user's personal information in a secure manner) into the smart card reader 50 and proceed to purchase the item. An application program is configured to allow the user to complete this type of transaction. Other options are available to the user as well.

The above invention has been described with specific embodiments, but a person skilled in the art could introduce many variations on these embodiments without departing from the spirit of the disclosure or from the scope of the appended claims. The embodiments are presented for the purpose of illustration only and should not be read as limiting the invention or its application. Therefore, the claims should be interpreted commensurate with the spirit and scope of the invention.

1. An interactive display extension device for use with a computer system, comprising:
memory means for storing information from said computer system;
processing means for processing said information stored in said memory means; and
display means, separate from a display means of said computer system, for displaying said information processed by said processing means;
wherein a user is allowed to interact with the interactive display extension device to request additional information to be displayed.

2. The interactive display extension device as set forth in claim 1, wherein the information displayed on the display means of the interactive display extension device is at least one of advertising information, news information, stock information, sports information, traffic information, emergency information, and weather information.

3. The interactive display extension device as set forth in claim 1, wherein the information is displayed on the display means of the interactive display extension device in static and/or moving images.

4. The interactive display extension device as set forth in claim 1, wherein the information is displayed on the display means of the interactive display extension device in text and/or graphic form.

5. The interactive display extension device as set forth in claim 1, further comprising audio output means for outputting the information in audio form.

6. The interactive display extension device as set forth in claim 1, wherein a data display bar is displayed on the display means of the computer system to facilitate user interaction with the information displayed on the display means of the interactive display extension device.

7. The interactive display extension device as set forth in claim 1, wherein the additional information is displayed on one of the display means of the interactive display extension device and the display means of the computer system.

8. The interactive display extension device as set forth in claim 1, further comprising attachment means for mechanically attaching the interactive display extension device to the display means of the computer system.

9. The interactive display extension device as set forth in claim 8, wherein the attachment means wraps around the display means of the computer system and clasps onto an edge of said display means of said computer system.

10. The interactive display extension device as set forth in claim 9, wherein the attachment means comprises a plurality of arms.

11. The interactive display extension device as set forth in claim 10, wherein the arms are movable to adjust a position of the interactive display extension device in relation to the display means of the computer system.

12. A method for displaying information on a separate display from a display of a computer system, comprising the steps of:
storing the information from said computer system;
processing the stored information;
displaying, on the separate display from the display of the computer system, the processed information; and
allowing user interaction so that a user may request additional information to be displayed.

13. The method as set forth in claim 12, wherein the information is at least one of advertising information, news information, stock information, sports information, traffic information, emergency information, and weather information.

14. The method as set forth in claim 12, further comprising the step of displaying the information in static and/or moving images.

15. The method as set forth in claim 12, further comprising the step of displaying the information in text and/or graphic form.

16. The method as set forth in claim 12, further comprising the step of outputting the information in audio form.

17. The method as set forth in claim 12, further comprising the step of displaying a data display bar on the display of the computer system to facilitate user interaction with the information displayed on the separate display.

18. The method as set forth in claim 12, further comprising the step of displaying the additional information on one of the separate display and the display of the computer system.

19. An interactive display extension system for use with a computer system, comprising:
a memory for storing information from said computer system;
a processor for processing the information stored in said memory; and
a display, separate from a display of said computer system, for displaying said information processed by said processor, wherein a user is allowed to interact with the information displayed on the separate display to request additional information to be displayed;
a data card which contains user information;
a data card reader adapted to access the user information contained on the data card when the data card is in communication therewith; and
an application program configured to allow the user to complete a transaction over a network based on the information or additional information displayed on the display, using the user information, when the data card is in communication with the data card reader.

20. The interactive display extension system as set forth in claim 19, wherein the information is at least one of advertising information, news information, stock information, sports information, traffic information, emergency information, and weather information.

21. The interactive display extension system as set forth in claim 19, further comprising audio output means for outputting the information in audio form.
